(19) United States
(12) Patent Application Publication
(10) Pub. No.: US 2023/0406341 A1
(43) Pub. Date: Dec. 21, 2023

(54) DRIVING ASSISTANCE APPARATUS, DRIVING ASSISTANCE METHOD, AND STORAGE MEDIUM STORING ASSISTANCE RECOMMENDATION PROGRAM

(71) Applicant: J-QuAD DYNAMICS Inc., Tokyo (JP)

(72) Inventor: YUKA SATRE, Tokyo (JP)

(21) Appl. No.: 18/450,311

(22) Filed: Aug. 15, 2023

Related U.S. Application Data
(63) Continuation of application No. PCT/JP2022/005236, filed on Feb. 10, 2022.

(30) Foreign Application Priority Data
Feb. 17, 2021 (JP) 2021-023483

(51) Int. Cl. B60W 50/14; G08G 1/16; B60W 30/12; B60W 30/09; B60Q 1/14; B60W 30/14

(52) U.S. Cl. CPC B60W 50/14; G08G 1/167; B60W 30/12; B60W 30/09; B60Q 1/1423; B60W 30/14; B60W 2540/215; B60W 2710/18; B60W 2552/40; B60W 2540/229

(57) ABSTRACT

By a driving assistance apparatus, a driving assistance method, or a storage medium storing an assistance recommendation program, association is stored data, wherein the association data associates a plurality of traveling situations with a plurality of situation assistance processes, and each situation assistance process is a driving assistance process for a specific traveling situation, a value of a traveling situation variable is acquired, a human interface is operated to propose at least one of the plurality of situation assistance processes, and a setting of an approved situation assistance process is enabled.

### CROSS REFERENCE TO RELATED APPLICATIONS

The present application is a continuation application of International Patent Application No. PCT/JP2022/005236 filed on Feb. 10, 2022, which designated the U.S. and claims the benefit of priority from Japanese Patent Application No. 2021-023483 filed on Feb. 17, 2021. The entire disclosures of all of the above applications are incorporated herein by reference.

### TECHNICAL FIELD

The present disclosure relates to a driving assistance apparatus, a driving assistance method, and a storage medium storing an assistance recommendation program.

### BACKGROUND

A device of a comparative example performs switching to automated driving when the degree of wakefulness of a driver is lowered.

### SUMMARY

By a driving assistance apparatus, a driving assistance method, or a storage medium storing an assistance recommendation program, association is stored data, wherein the association data associates a plurality of traveling situations with a plurality of situation assistance processes, and each situation assistance process is a driving assistance process for a specific traveling situation, a value of a traveling situation variable is acquired, a human interface is operated to propose at least one of the plurality of situation assistance processes, and a setting of an approved situation assistance process is enabled.

### BRIEF DESCRIPTION OF DRAWINGS

The above and other features and advantages of the present disclosure will become more apparent from the following detailed description made with reference to the accompanying drawings.

FIG. 1 is a block diagram showing a configuration of a vehicle equipped with a driving assistance apparatus according to one embodiment.

FIG. 2 is a diagram illustrating matrix data according to the embodiment.

FIG. 3 is a flowchart showing a procedure of processes executed by an ADAS ECU according to the embodiment.

FIG. 4 is a flowchart showing a procedure of processes executed by the ADAS ECU according to the embodiment.

FIG. 5 is a flowchart showing a procedure of processes executed by the ADAS ECU according to the embodiment.

FIG. 6 is a flowchart showing a procedure of processes executed by the ADAS ECU according to the embodiment.

FIG. 7 is a flowchart showing a procedure of processes executed by the ADAS ECU according to the embodiment.

FIG. 8 is a diagram showing examples of switching of a driving assistance setting according to the embodiment.

FIG. 9 is a diagram showing examples of switching of the driving assistance setting according to the embodiment.

FIG. 10 is a diagram showing examples of switching of the driving assistance setting according to the embodiment.

### DETAILED DESCRIPTION

The device automatically turns on a safety function to cope with a driver abnormality. By the way, multiple safety functions for assisting driving of a vehicle have been put into practical use. Some of them are executed by the driver manually switching to an enabled state. However, it is troublesome for the driver to select an appropriate process for the current situation from among multiple driving assistance processes each time.

According to one example embodiment, a driving assistance apparatus for assisting driving of a vehicle includes: a storage configured to store association data; an execution device. The association data associates a plurality of traveling situations with a plurality of situation assistance processes. Each situation assistance process is a driving assistance process for a specific traveling situation. The execution device is configured to: acquire a value of a traveling situation variable that is a variable indicating a traveling situation of the vehicle among the plurality of traveling situations; operate a human interface to propose, to a driver of the vehicle, at least one of the plurality of situation assistance processes according to the association data based on the value of the traveling situation variable; and when detecting that the driver has approved a proposal of the at least one of the plurality of situation assistance processes via the human interface, enable a setting of an approved situation assistance process.

According to another example embodiment, a driving assistance method includes: storing association data in a storage, wherein the association data associates a plurality of traveling situations with a plurality of situation assistance processes, and each situation assistance process is a driving assistance process for a specific traveling situation; acquiring a value of a traveling situation variable that is a variable indicating a traveling situation of the vehicle among the plurality of traveling situations; operating a human interface to propose, to a driver of the vehicle, at least one of the plurality of situation assistance processes according to the association data based on the value of the traveling situation variable; and when detecting that the driver has approved a proposal of the at least one of the plurality of situation assistance processes via the human interface, enabling a setting of an approved situation assistance process.

Further, according to another example embodiment, a computer-readable non-transitory storage medium stores an assistance recommendation program configured to cause a processor to: store association data in a storage, wherein the association data associates a plurality of traveling situations with a plurality of situation assistance processes, and each situation assistance process is a driving assistance process for a specific traveling situation; acquire a value of a traveling situation variable that is a variable indicating a traveling situation of the vehicle among the plurality of traveling situations; operate a human interface to propose, to a driver of the vehicle, at least one of the plurality of situation assistance processes according to the association data based on the value of the traveling situation variable; and when detecting that the driver has approved a proposal of the at least one of the plurality of situation assistance processes via the human interface, enable a setting of an approved situation assistance process.

In the above configuration, data for associating the plurality of traveling situations with the plurality of situation assistance processes is stored in advance, and it is proposed to enable the situation assistance process associated with the traveling situation. Thereby, it is possible to determine whether to enable or disable the process when the enablement is proposed according to the situation instead of selecting, by the driver, whether to enable each of the plurality of driving assistance processes. Therefore, it is possible to prevent the driver selection of whether to enable or disable the driving assistance process from becoming complicated.

### First Embodiment

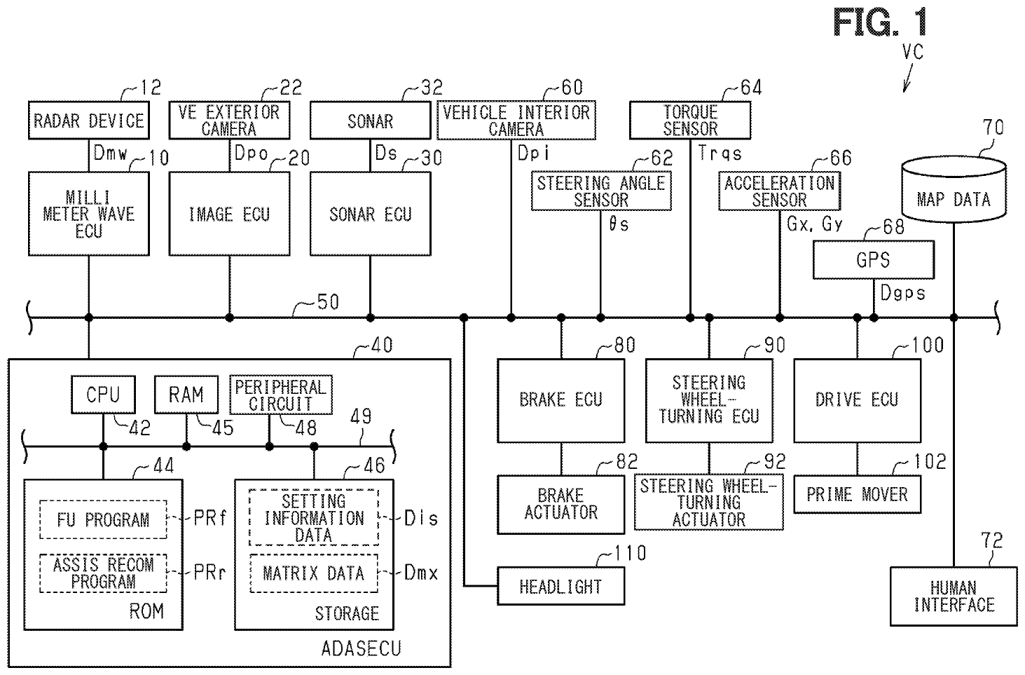

Hereinafter, a first embodiment will be described with reference to the drawings. FIG. 1 shows a part of a configuration of a vehicle VC according to the present embodiment.

As shown in FIG. 1, a radar device 12 transmits millimeter wave radar a periphery of the vehicle VC, receives the millimeter wave radar reflected from an object around the vehicle VC, and outputs, as millimeter wave data Dmw, signals related to a distance with the object, which has reflected the millimeter wave radar. The millimeter wave data Dmw is taken into a millimeter wave ECU 10. The millimeter wave ECU 10 executes a recognition process for recognizing the object in the periphery of the vehicle VC based on the millimeter wave data Dmw.

Vehicle exterior image data Dpo, which is data related to an image captured by a vehicle exterior camera 22, is input to an image ECU 20. The image ECU 20 executes the recognition process for recognizing the object in the periphery of the vehicle VC based on the vehicle exterior image data Dpo.

A sonar 32 outputs sound wave signals to the periphery of the vehicle VC and receives sound wave signals reflected from an object in the periphery of the vehicle VC to output signals related to a distance with the object as reflection sound wave data Ds. A sonar ECU 30 executes processing for recognizing objects around the vehicle VC based on the reflection sound wave data Ds.

An ADAS (Advance driver assistance system) ECU 40 is an electronic control unit that assists the driver in driving of the vehicle VC. The ADAS ECU 40 has a CPU 42, a ROM 44, a RAM 45, a storage device 46, and a peripheral circuit 48 which are connected via a communication line 49. The CPU 42 and the ROM 44 may be also referred to as execution devices.

The ROM 44 stores a function unit program PRf and an assistance recommendation program PRr. In the drawings, the expressions of “function unit” may be also referred to as “FU”, and the expression of “assistance recommendation” may be also referred to as “ASSI RECOM”. The function unit program PRf is a program that defines commands to the CPU 42 for executing each driving assistance process of multiple function units. The driving assistance process (hereinafter referred to as a function unit assistance process) in units of functions is a driving assistance process having one function, such as collision avoidance or cruise control, depending on the situation and purpose. The vehicle according to the present embodiment is capable of executing multiple driving assistance processes because the function unit program PRf defines multiple driving assistance processes for multiple functions. The assistance recommendation program PRr is a program defining commands for the CPU 42 to execute a process of proposing to the driver that some of the assistance processes for multiple functions should be enabled.

The ADAS ECU 40 refers to the result of object recognition by the millimeter wave ECU 10, the result of object recognition by the image ECU 20, and the result of object recognition by the sonar ECU 30 via an in-vehicle network 50 when assisting driving. Further, the ADAS ECU 40 refers to the vehicle interior image data Dpi captured by the in-vehicle camera 60 that captures the image of the driver. Further, the ADAS ECU 40 refers to a wheel-turning angle θs of the steered wheels detected by a steering angle sensor 62 and a steering torque Trqs detected by a torque sensor 64. The steering torque Trqs is a torque input to the steering wheel. Further, the ADAS ECU 40 refers to a longitudinal acceleration Gx and lateral acceleration Gy of the vehicle VC detected by an acceleration sensor 66. Further, the ADAS ECU 40 refers to position data Dgps output by a global positioning system (GPS 68) and map data 70. Then, the ADAS ECU 40 outputs various commands for driving assistance to a brake ECU 80, a wheel-turning ECU 90, a drive ECU 100 and a headlight 110.

The brake ECU 80 is an electronic control unit that controls a braking force of the vehicle VC by operating a brake actuator 82. The wheel-turning ECU 90 is an actuator that controls the wheel-turning angle θs by operating a wheel-turning actuator 92. The drive ECU 100 is an electronic control unit that controls the drive force of the vehicle VC by operating a prime mover 102 that generates the thrust of the vehicle VC.

The storage device 46 of the ADAS ECU 40 is an electrically rewritable memory. The storage device 46 stores setting information data Dis and matrix data Dmx. The matrix data Dmx may be also referred to as association data.

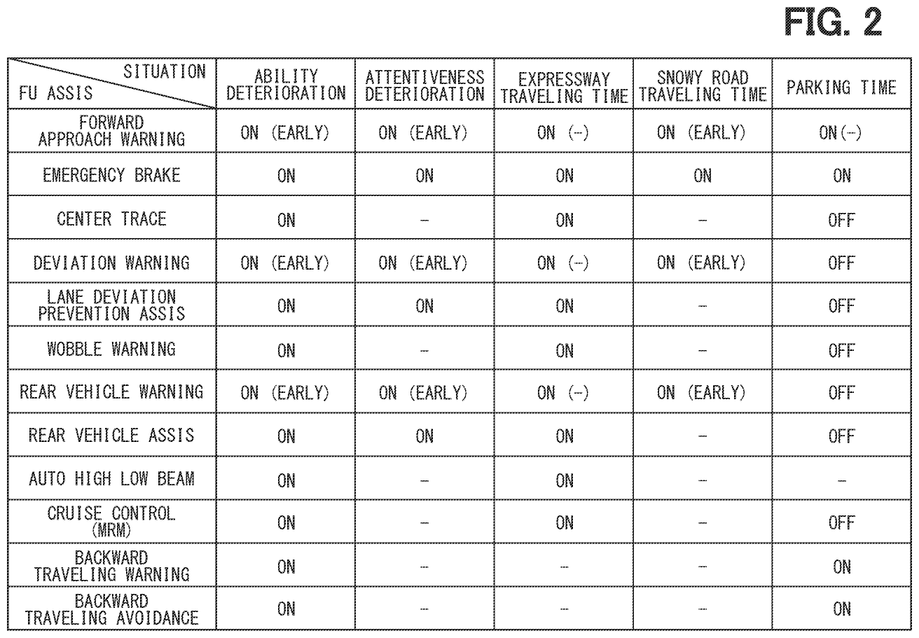

FIG. 2 shows the matrix data Dmx.

The matrix data Dmx is data used when the CPU 42 executes commands defined in the assistance recommendation program PRr. The matrix data Dmx defines the relationship between the function unit assistance processes defined by the function unit program PRf and some situations.

As shown in FIG. 2, the function unit assistance process includes a forward approach warning process. In drawings, the expression of “process” may be omitted. The forward approach warning process is a process of operating a human interface 72 to issue a warning when it is determined that there is an obstacle that is positioned in front of the vehicle VC and may come into contact with the vehicle VC. The forward approach warning process takes the output of the millimeter wave ECU 10 and the output of the image ECU 20 as inputs. Further, the function unit assistance process includes an emergency brake process. The emergency brake process is a process of automatically operating the brake independently of the driver brake operation when there is the obstacle that is positioned in front of the vehicle VC, in other words, positioned in the advancing direction and may come into contact with the vehicle VC. Specifically, this is a process in which the brake ECU 80 operates the brake actuator 82 to output to the brake ECU 80 a command for applying the braking force. The emergency brake process takes as input the output of the millimeter wave ECU 10 and the output of the image ECU 20.

A center trace process is a process of minutely controlling the wheel-turning angle θs independently of the driver operation of the steering wheel so that the vehicle VC travels near the center of the lane. Specifically, it is a process of slightly correcting the wheel-turning angle θs so that the vehicle VC is positioned in the center of the lane while respecting the operation of the steering wheel by the driver. Specifically, it is a process of outputting the correction amount of the wheel-turning angle θs to the wheel-turning ECU 90. The center trace process uses the output of the image ECU 20 as the input.

Further, the functional unit assistance process includes a deviation warning process. The deviation warning process is a process (also referred to a warning assistance process) of operating the human interface 72 to issue the warning so that the vehicle VC does not largely deviate from the lane. The deviation warning process takes the output of the image ECU 20 as the input. A lane deviation prevention assistance process is a process for minutely controlling the wheel-turning angle θs independently of the operation of the steering wheel by the driver so that the vehicle VC does not largely deviate from the lane. Specifically, it is a process of slightly correcting the wheel-turning angle θs so that the vehicle VC does not largely deviate from the lane while respecting the operation of the steering wheel by the driver. Specifically, it is a process of outputting the correction amount of the wheel-turning angle θs to the wheel-turning ECU 90. The output of the image ECU 20 is input to the lane deviation prevention assistance process. Further, the functional unit assistance process includes a wobble warning process. The wobble warning process is a process of operating the human interface 72 to issue the warning when the vehicle VC does not travel straight along the lane and wobbles from side to side. The wobble warning process takes the output of the image ECU 20 and the lateral acceleration Gy as inputs.

A rear vehicle warning process is a process of operating the human interface 72 to issue a warning when there is a risk of contact with a vehicle traveling backward due to a lane change or the like of the vehicle VC. The rear vehicle warning process takes the output of the millimeter wave ECU 10 and the output of the image ECU 20 as inputs. Further, the function unit assistance process includes a rear vehicle assistance process. The rear vehicle assistance process is a process for controlling the wheel-turning angle θs so as to automatically prevent the vehicle VC from coming into contact with the traveling rear vehicle, independently of the operation of the steering wheel by the driver, when there is a risk of the vehicle VC coming into contact with the rear vehicle due to a lane change or the like. Specifically, it is a process of outputting a command value of the wheel-turning angle θs to the wheel-turning ECU 90. At this time, a process of outputting a command to at least one of brake ECU 80 and drive ECU 100 may be added. The rear vehicle assistance process takes the output of the millimeter wave ECU 10 and the output of the image ECU 20 as inputs.

Also, the function unit assistance process includes an auto high-low beam process. The auto high-low beam process is a process of automatically switching the headlight 110 between a high beam state and a low beam state according to the peripheral condition of the vehicle VC. The auto high-low beam process takes the output of the image ECU 20, the position data Dgps, and the map data 70 as inputs. Also, the function unit assistance processes includes a cruise control process. The cruise control process is a process for causing the vehicle VC to automatically travel along the lane on an automobile road or the like in a state where there is no driving operation by the driver. The cruise control process takes the output of the millimeter wave ECU 10, the output of the image ECU 20, the position data Dgps, and the map data 70 as inputs. The cruise control process includes a minimal risk maneuver process (MRM). The MRM is a process of causing the vehicle VC to automatically travel to a safe area and stop it when there is an obstacle to driving, such as a situation where the driver is losing consciousness based on the in-vehicle image data Dpi.

Further, the functional unit assistance process includes a backward traveling warning process. The backward traveling warning process is a process of operating the human interface 72 to issue a warning in a case where there is a risk that it is determined that the vehicle VC may come into contact with the object when going backward in a parking lot or the like based on the output of the sonar ECU 30. Further, the functional unit assistance process includes a backward traveling avoidance process. The backward traveling avoidance process is a process of applying the braking force to the vehicle VC, in a case where it is determined, based on the output of the sonar ECU 30, that there is a risk of contact with the object when the vehicle VC is going backwards in the parking lot or the like. The applied braking force is independent of the driving operation by the driver. Specifically, it is a process of outputting a command to the brake ECU 80.

The matrix data Dmx is data that defines a process that is recommended to be enabled according to the situation, among twelve functional unit assistance processes described above. Here, five situations are illustrated as the situations. That is, a situation where the driver driving ability has deteriorated and a situation where the driver attentiveness has deteriorated are exemplified as the driving situation of the driver. Further, as traveling situations of the vehicle VC, a situation of traveling on an expressway, a situation of traveling on a snowy road, and a situation of parking are exemplified.

Enabling the function unit assistance process means setting the function unit assistance process to a standby state. That is, for example, when the cruise control process is enabled, it means that the cruise control process is started when a predetermined condition is satisfied. In this case, the predetermined condition is, for example, a condition that the vehicle VC is traveling on an automobile road, a condition that the driver is not operating the steering wheel, a condition that the driver is not stepping on the brake pedal, or a condition that the driver does not operate the accelerator pedal. Accordingly, even when the cruise control process is enabled, the cruise control process is not executed when the vehicle VC is traveling on a general road because the conditions are not satisfied. When the cruise control process is enabled, the vehicle VC enters the expressway and the driver releases the operations of the steering wheel, the brake pedal and the accelerator pedal to initiate the cruise control process.

In FIG. 2, the enabled state is described as “ON”. Further, a hyphen indicates that the state set by the driver process, which will be described later, is inherited.

As shown in FIG. 2, the state where the driving ability has deteriorated is associated with the enabled states of all the twelve functional unit assistance processes. Moreover, in situations where the driving ability has deteriorated, the forward approach warning process, the deviation warning process, and the rear vehicle warning process are associated with settings that advance the timing at which warnings are issued. Further, ten processes other than two of the twelve function unit assistance processes are associated with the state of traveling on the expressway. The two processes are the backward traveling warning process and the backward traveling avoidance process. In FIG. 2, “(−)” is written after “ON” for the forward approach warning process, the deviation warning process, and the rear vehicle warning process. This means that the value set by the driver process, which will be described later, is adopted as the timing for issuing the warning.

The ADAS ECU 40 executes a process of changing whether each of the function unit assistance processes is enabled or disabled by setting by the driver.

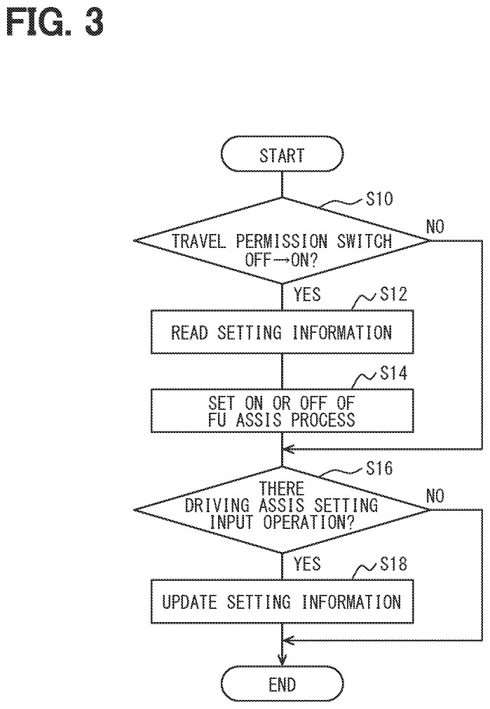

FIG. 3 particularly shows the procedure of a change process among processes executed by the ADAS ECU 40. The processes shown in FIG. 3 are implemented by the CPU 42 repeatedly executing a program stored in the ROM 44, for example, at predetermined intervals. Hereinafter, the process number of each process is represented by a number prefixed with “S”.

In the series of processes shown in FIG. 3, the CPU 42 first determines whether a travel permission switch of the vehicle VC has been changed from the OFF state to the ON state (S10). Here, the travel permission switch is a switch for switching from a state where the vehicle VC cannot travel to a state where the vehicle VC can travel by an operation by the driver. For example, when a prime mover 102 is only an engine, the ignition switch may be used as the travel permission switch. Further, for example, when the prime mover 102 includes an electric motor, the travel permission switch may be a switch that closes a switch between a drive circuit connected to the electric motor and the battery. The process of S10 is a process of determining whether it is time to start a trip, which is one period in which the travel permission switch is in the ON state.

When determining that it is time to switch the state from the OFF state to the ON state (S10: YES), the CPU 42 reads the setting information indicating whether the driver has enabled or disabled each of the 12 function unit assistance processes indicated by the setting information data Dis (S12). Next, the CPU 42 sets each state read by the process of S12 to the state of the function unit assistance process at the start of the trip (S14). This process is implemented by the CPU 42 writing to the RAM 45 whether each of the 12 function unit assistance processes is enabled or disabled. That is, in this embodiment, whether the function unit assistance process is enabled or disabled is determined according to whether the state stored in the RAM 45 is enabled or disabled. The setting information data Dis also includes information that determines whether the warning timing is late, normal, or early for the forward approach warning process, the deviation warning process, and the rear vehicle warning process. Then, in the process of S14, the CPU 42 writes in the RAM 45 the timing of issuing the warning for the process in the enabled state among the above three processes indicated by the setting information data Dis.

When the process of S14 is completed, or when a negative determination is made in the process of S10, the CPU 42 determines whether the driver operates the human interface 72 to manually set the state of some function unit assistance process (S16). This process may be implemented by, for example, configuring the human interface 72 with a display and a touch panel arranged over the display. In that case, twelve function unit assistance processes are displayed on the display, and the state of the function unit assistance process instructed by the driver via the touch panel can be switched. When determining that the setting is to be made manually (S16: YES), the CPU 42 updates the setting information data Dis stored in the storage device 46 (S18).

When the process of S18 is completed or when the negative determination is made in the process of S16, the CPU 42 temporarily ends the series of processes shown in FIG. 3.

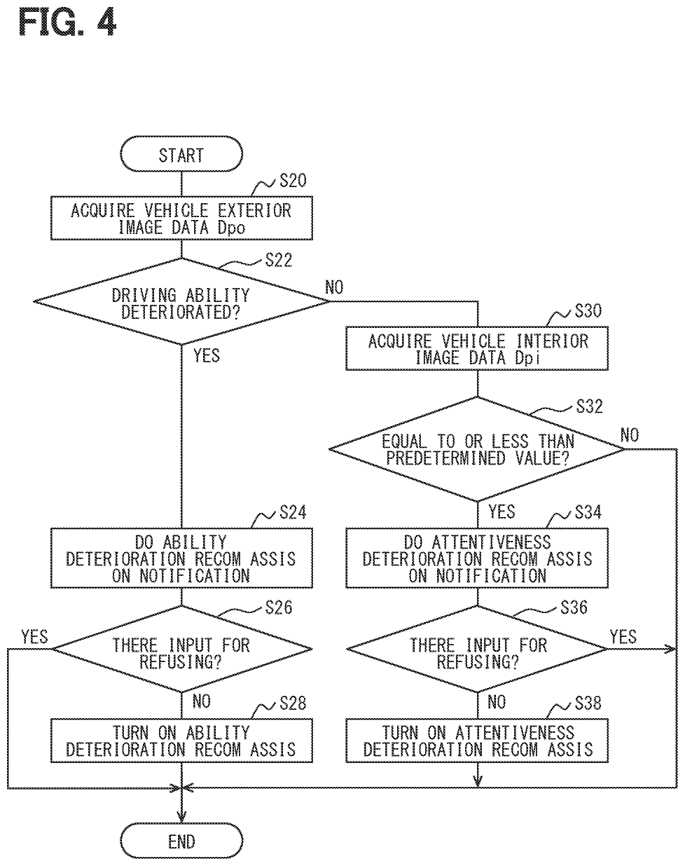

FIG. 4 shows a procedure of processes for validating some of the function unit assistance processes according to the driving situation. The processes shown in FIG. 4 are implemented by the CPU 42 executing the assistance recommendation program PRr stored in the ROM 44.

In the series of processes shown in FIG. 4, the CPU 42 first acquires the vehicle exterior image data Dpo (S20). Then, the CPU 42 determines whether the driving ability of the driver of the vehicle VC has deteriorated based on the time-series data of the vehicle exterior image data Dpo (S22). The processes in S20 and S22 correspond to an unstable situation assistance process. Here, from the time-series data of the vehicle exterior image data Dpo, the CPU 42 determines that the driving ability has deteriorated when the vehicle VC does not travel straight along the lane but sways from side to side. In other words, the CPU 42 determines that the driving ability has deteriorated when the traveling of the vehicle VC is wobbling. When determining that the driving ability has deteriorated (S22: YES), the CPU 42 provides a notification that an ability deterioration time recommendation assistance of the driving assistance process associated with the state in the first column of the matrix data Dmx shown in FIG. 2 is turned on (S24). Here, for example, a speaker may be provided in the human interface 72, and provide an audio guidance of “Because it seems that a worried situation has occurred about safe driving, put various driving assistance functions into the standby state. If you refuse, please operate . . . ”.

Then, the CPU 42 determines whether there is an input operation for rejecting the notification process of S24 (S26). In this process, for example, the human interface 72 may be provided with a microphone, and when a negative voice input operation such as “NO” is performed within a predetermined period, it may be determined that the input operation for refusing the voice input operation has been performed. When the CPU 42 determines that there is no input operation for refusal (S26: NO), the CPU 42 turns on the ability deterioration time recommendation assistance (S28). That is, the CPU 42 sets all of the 12 functional unit assistance processes stored in the RAM 45 to the enabled state. At this time, the CPU 42 sets, to a value indicating the early timing, a value of the variable indicating the timing of issuing the warning in each of the three processes of the forward approach warning process, the deviation warning process, and the rear vehicle warning process stored in the RAM 45.

On the other hand, when determining that the driving ability has not deteriorated (S22: NO), the CPU 42 acquires the vehicle interior image data Dpi (S30). Then, the CPU 42 monitors the vehicle interior image data Dpi to determine whether the driver attentiveness is equal to or lower than a predetermined value (S32). Here, the CPU 42 specifies a line-of-sight direction of the driver from the vehicle interior image data Dpi. When the rate of time that the line-of-sight direction deviates from the forward traveling direction of the vehicle VC is equal to or greater than a predetermined rate, the CPU 42 determines that the attentiveness is equal to or less than the predetermined value (S32). When determining that the attentiveness has deteriorated (S32: YES), the CPU 42 provides a notification that an attentiveness deterioration time recommendation assistance of the driving assistance process associated with the state in the second column of the matrix data Dmx shown in FIG. 2 is turned on (S34). Here, for example, the speaker may be provided in the human interface 72, and provide an audio guidance of “Because it seems to be difficult to focus on driving, put various driving assistance functions into the standby state. If you refuse, please operate . . . ”.

Then, the CPU 42 determines whether there is an input operation for refusing the notification process of S34 in the same manner as the process of S26 (S36). When the CPU 42 determines that there is no input operation for refusal (S36: NO), the CPU 42 turns on the attentiveness deterioration time recommendation assistance (S38). That is, the CPU 42 updates the state of the twelve functional unit assistance processes stored in the RAM 45 according to the state of the second column of the matrix data Dmx. Specifically, in the second column of the matrix data Dmx shown in FIG. 2, six function unit assistance processes are turned on. Therefore, among them, the process with the OFF state stored in the RAM 45 is rewritten to the ON state. On the other hand, since the remaining six function unit assistance processes are hyphenated, the state stored in the RAM 45 is maintained. At this time, the CPU 42 sets, to a value indicating the early timing, a value of the variable indicating the timing of issuing the warning in each of the three processes of the forward approach warning process, the deviation warning process, and the rear vehicle warning process stored in the RAM 45.

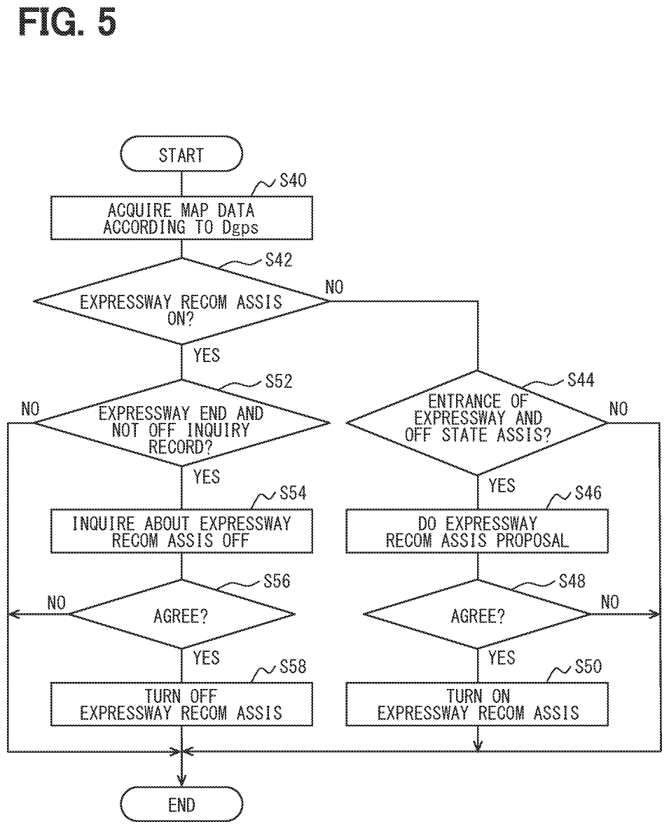

When the processes of S28 and S38 is completed or when the negative determination is made in the processes of S26, S32, and S36, the CPU 42 temporarily ends the series of processes shown in FIG. 4. FIG. 5 shows a procedure of a process of switching a state of an expressway recommendation assistance. The process is the driving assistance process associated with the third column of the matrix data Dmx. The processes shown in FIG. 5 are implemented by the CPU 42 executing the assistance recommendation program PRr stored in the ROM 44.

In the series of processes shown in FIG. 5, the CPU 42 first acquires data near the position of the vehicle VC indicated by the position data Dgps from the map data 70 (S40). This process is a process of acquiring the value of a traveling situation variable, which is a variable indicating the traveling situation of the vehicle VC specified by the map data. Then, the CPU 42 determines whether the expressway recommendation assistance has been turned on by a process of S50 described later (S42). When determining that the expressway recommendation assistance is in the OFF state (S42: NO), the CPU 42 determines whether a logical product of the following two conditions is true (S44).
It is a condition that it is judged to be the entrance of the expressway based on the map data. That is, the condition is that the value of the traveling condition variable, which is the variable indicating the traveling situation of the vehicle VC specified by the map data, is a value of the variable indicating an entrance of the expressway.
The condition is that some of the function unit assistance processes that are enabled by the expressway recommendation assistance are disabled.

When the CPU 42 determines that the logical product is true (S44: YES), the CPU 42 makes a proposal to turn on the expressway recommendation assistance (S46). Here, for example, the human interface 72 may be provided with the speaker, and perform voice guidance of “Do you need to set the driving assistance process suitable for expressways to the standby state?”.

Then, the CPU 42 determines whether the driver agrees with the proposal (S48). For example, in the process, the human interface 72 may be provided with the microphone, and it may be determined whether the driver makes a voice input such as “OK” within a predetermined time after the proposal. When determining that the driver has agreed (S48: YES), the CPU 42 enables the expressway recommendation assistance (S50). That is, the CPU 42 rewrites, to the enabled state, the disabled state that is stored in the RAM 45 and a state of a process other than the backward traveling warning process and the backward traveling avoidance process among twelve function assistance processes shown in FIG. 2. At this time, when rewriting the disabled states to the enabled states of the three processes of the forward approach warning process, the deviation warning process, and the rear vehicle warning process, the timings are set to a timing specified in the setting information data Dis. When there is no timing setting in the setting information data Dis, it is set to “Normal” by default.

On the other hand, when the CPU 42 determines that the expressway recommendation assistance is ON (S42: YES), the CPU 42 determines whether there is a record of inquiring for setting the expressway recommendation assistance to the OFF state after the expressway ends (S52). When there is no record of the inquiry after the end of the expressway (S52: YES), the CPU 42 inquires whether the expressway recommendation assistance may be turned off (S54). Here, for example, the human interface 72 may be provided with the speaker, and perform voice guidance of “Is it OK to disable the driving assistance process suitable for expressways?”.

Then, the CPU 42 determines whether the driver agrees to disable the process (S56). For example, in the process, the human interface 72 may be provided with the microphone, and it may be determined whether the driver makes a voice input such as “OK” within a predetermined time after the inquiry. When determining that the driver has agreed (S56: YES), the CPU 42 disables the expressway recommendation assistance (S58). At this time, the function unit assistance process enabled before the expressway recommendation assistance has been enabled is maintained in the enabled state. Further, when another process for enabling a predetermined function unit assistance process is entered after the expressway recommendation assistance is enabled, the function unit assistance process is also maintained in the enabled state.

When the processes of S50 and S58 is completed or when the negative determination is made in the processes of S44, S48, S52, and S56, the CPU 42 temporarily ends the series of processes shown in FIG. 5.

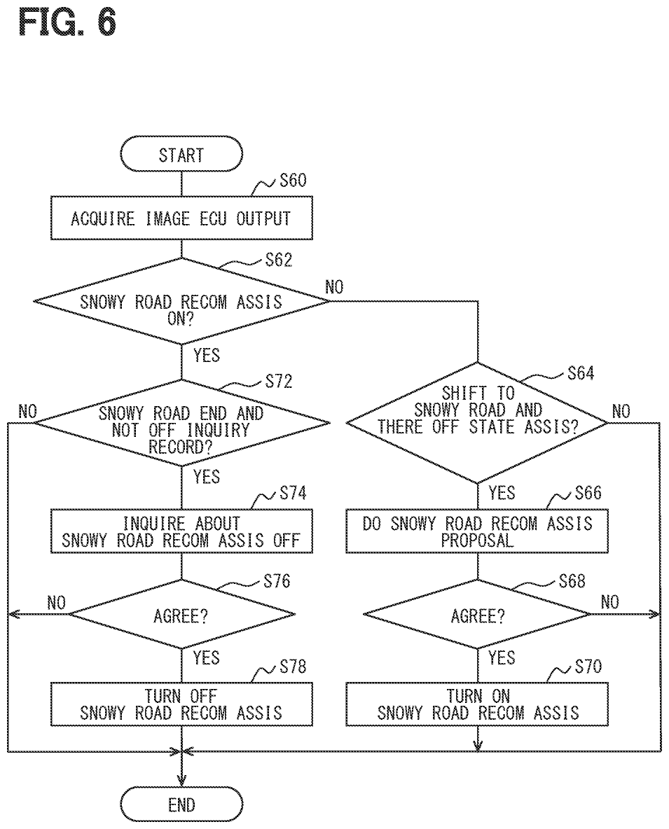

FIG. 6 shows a procedure of a process of switching a state of a snowy road recommendation assistance. The process is the driving assistance process associated with the fourth column of the matrix data Dmx. The processes shown in FIG. 6 are implemented by the CPU 42 executing the assistance recommendation program PRr stored in the ROM 44.

In the series of processes shown in FIG. 6, the CPU 42 first acquires the output of the image ECU 20 (S60). This process is a process of acquiring the value of the traveling situation variable specified based on the output of the image ECU 20. Next, the CPU 42 determines whether the snowy road recommendation assistance support is ON (S62). When determining that the snowy road recommendation assistance is OFF (S62: NO), the CPU 42 determines whether a logical product of the following two conditions is true (S64).
The condition is that it is determined, based on the output of the image ECU 20, that a state of the road surface on which the vehicle VC is traveling has changed from not covered with snow to covered with snow. In other words, it is a condition for determining that the vehicle VC has transitioned to a state of traveling on a snowy road. That is, the condition is that the value of the traveling situation variable specified based on the output of the image ECU 20 has changed from a value that does not indicate the snowy road to a value that indicates the snowy road.
The condition is that at least a part of the state of the function unit assistance process specified by the snowy road recommendation assistance differs from the current state.

When determining that the logical product is true (S64: YES), the CPU 42 proposes to turn on the snowy road recommendation assistance (S66). Here, for example, the human interface 72 may be provided with the speaker, and output voice of “Do you need to set the driving assistance process suitable for snowy roads to the standby state?”.

Then, the CPU 42 determines whether the driver agrees with the proposal in the similar manner to the process of S48 (S68). When determining that the driver has agreed (S68: YES), the CPU 42 enables the snowy road recommendation assistance (S70). That is, the CPU 42 rewrites, to the enabled state, the disabled state, which is stored in the RAM 45 and a state of the forward approach warning process, the emergency brake process, the deviation warning process, or the rear vehicle warning process. At this time, the CPU 42 sets, to early timing, the timing of issuing the warning in each of the three processes of the forward approach warning process, the deviation warning process, and the rear vehicle warning process.

On the other hand, when the CPU 42 determines that the snowy road recommendation assistance is ON (S62: YES), the CPU 42 determines whether there is a record of inquiring for setting the snowy road recommendation assistance to be OFF after the snowy road ends (S72). When there is no record of the inquiry after the end of the snowy road (S72: YES), the CPU 42 inquires whether the snowy road recommendation assistance may be turned off in the similar manner to the process in S54 (S74).

Then, the CPU 42 determines whether the driver agrees with the proposal for returning to the disabled state in the similar manner to the process of S56 (S76). When determining that the driver has agreed (S76: YES), the CPU 42 disables the snowy road recommendation assistance (S78). At this time, the CPU 42 maintains the function unit assistance process, that has been enabled before the snowy road recommendation assistance has been enabled, in the enabled state. Further, when another process for enabling a predetermined function unit assistance process is entered after the snowy road recommendation assistance is enabled, the CPU 42 maintains also the function unit assistance process in the enabled state.

When the processes of S70 and S78 is completed or when the negative determination is made in the processes of S64, S68, S72, and S76, the CPU 42 temporarily ends the series of processes shown in FIG. 6.

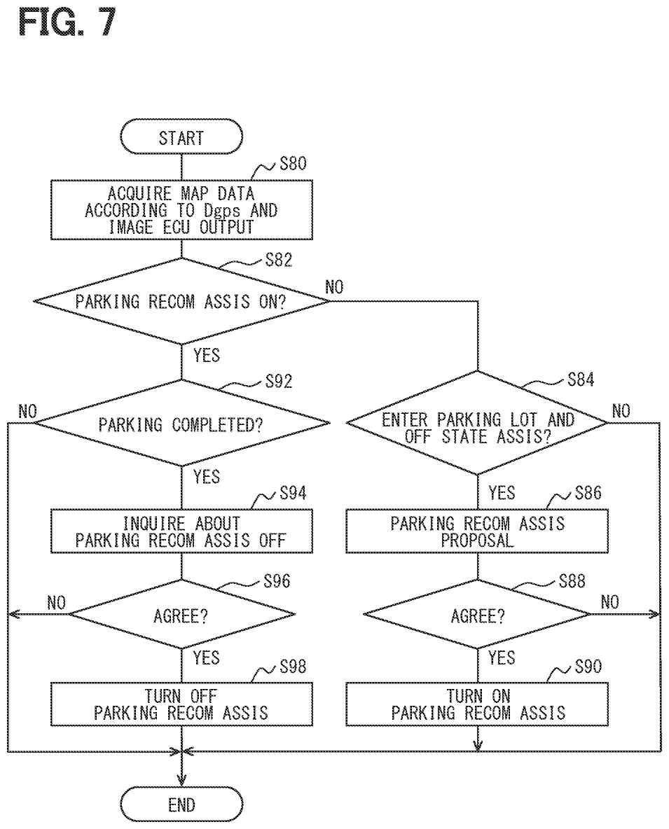

FIG. 7 shows a procedure of a process of switching a state of a parking recommendation assistance. The process is the driving assistance process associated with the fifth column of the matrix data Dmx. The processes shown in FIG. 7 are implemented by the CPU 42 executing the assistance recommendation program PRr stored in the ROM 44.

In the series of processes shown in FIG. 7, the CPU 42 first acquires data indicated by the position data Dgps and the output of the image ECU 20 from the map data 70 (S80). This process is a process of acquiring the value of the traveling situation variable specified based on the above-described data and the output of the image ECU 20. Next, the CPU 42 determines whether the parking recommendation assistance support is ON (S82). When determining that the parking recommendation assistance is OFF (S82: NO), the CPU 42 determines whether a logical product of the following two conditions is true (S84).
The condition is a condition for determining that the vehicle VC has entered the parking lot based on the above-described data and the output of the image ECU That is, the condition is that the value of the traveling situation variable, which is specified based on the above-described data and the output of the image ECU 20, is a value that indicates the parking lot.
The condition is a condition that some of the function unit assistance processes that are enabled by the parking recommendation assistance are disabled. When determining the logical product to be true (S84: YES), the CPU 42 proposes to turn on the parking road recommendation assistance (S86). Here, for example, the human interface 72 may be provided with the speaker, and output voice of “Do you need to put the driving assistance process suitable for parking into the standby state?”.

Then, the CPU 42 determines whether the driver agrees with the proposal in the similar manner to the process of S48 (S88). When determining that the driver has agreed (S88: YES), the CPU 42 enables the parking recommendation assistance (S90). That is, the CPU 42 rewrites, to the enabled state, the disabled state that is stored in the RAM 45 and a state of the backward traveling warning process and the backward traveling avoidance process.

On the other hand, when the CPU 42 determines that the parking recommendation assistance is in the ON state (S82: YES), it determines whether the parking has been completed (S92). When determining that parking has been completed (S92: YES), the CPU 42 inquires whether the parking recommendation assistance may be turned off in the similar manner to the process of S54 (S94).

Then, the CPU 42 determines whether the driver agrees with the proposal for returning to the disabled state in the similar manner to the process of S56 (S96). When determining that the driver has agreed (S96: YES), the CPU 42 disables the parking recommendation assistance (S98). At this time, the CPU 42 maintains the function unit assistance process, that has been enabled before the parking road recommendation assistance has been turned on, in the enabled state. That is, for example, the CPU 42 sets the backward traveling warning process to the enabled state by the process of S14, and maintains the enabled state when the enabled state is maintained immediately before the recommendation parking assistance is turned on.

When the processes of S90 and S98 are completed or when the negative determination is made in the processes of S84, S88, S92, and S96, the CPU 42 temporarily ends the series of processes shown in FIG. 7.

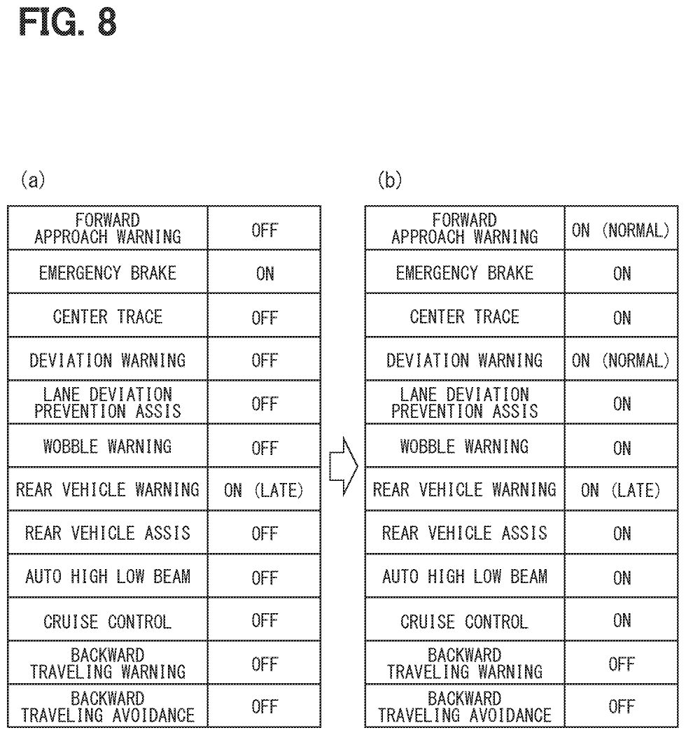

Here, the action and effect of the present embodiment will be described. When the trip starts, the CPU 42 writes, to the RAM 45, whether each of the 12 function unit assistance processes is enabled or disabled based on the setting information data Dis. A part (a) of FIG. 8 illustrates the state set in such a manner. In this example, two processes of the emergency brake process and the rear vehicle warning process are enabled by the setting information data Dis. In particular, in this example, the setting is such that the timing of issuing the warning in the rear vehicle warning process is delayed.

When the vehicle VC reaches the entrance of the expressway by the traveling of the vehicle VC, the CPU 42 proposes to the driver to turn on the expressway recommendation assistance. When the driver agrees to the proposal, the CPU 42 switches, to the enabled state, a state of a process that is stored in the RAM 45 and should be enabled by the expressway recommendation assistance among twelve function unit assistance processes.

A part (b) of FIG. 8 shows a state stored in the RAM 45 when the expressway recommendation assistance is turned on. As shown in the part (b) of FIG. 8, the ten function unit assistance processes excluding two processes of backward traveling warning process and backward traveling avoidance process are enabled. Here, the timing of issuing the warning in the two processes of the forward approach warning process and the deviation warning process is “normal”. This is because there is no timing setting information in the setting information data Dis, so the standard timing is set by default.

After that, when the vehicle VC shifts to a snowy road, the CPU 42 proposes to turn on the snowy road recommendation assistance. When the driver agrees to the proposal, the CPU 42 updates the states of twelve function unit assistance processes in the RAM 45 according to the snowy road driving assistance.

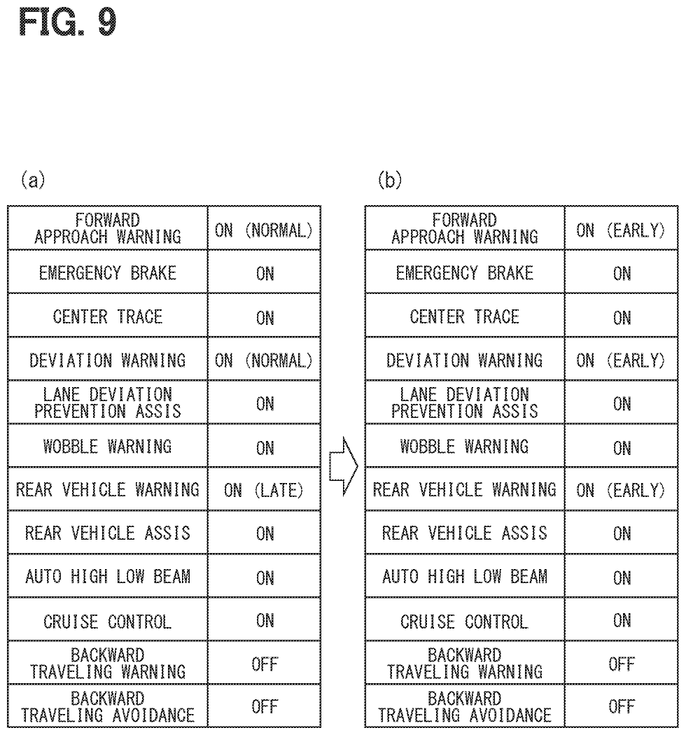

A part (a) of FIG. 9 shows a state before the snowy road recommendation assistance is turned on, and a part (b) of FIG. 9 shows a state after the snowy road recommendation assistance is turned on. In this example, all function unit assistance processes, which should be enabled by the snowy road recommendation assistance, have been enabled before the update. However, the timing of issuing warnings in the three processes of forward approach warning process, deviation warning process, and rear vehicle warning process is different from the setting by the snowy road recommendation assistance. In that case, the CPU 42 gives priority to the earlier timing, and switches to the timing according to the snowy road recommendation assistance.

After that, when the vehicle VC leaves the snowy road, the CPU 42 inquires of the driver whether the snowy road recommendation assistance may be turned off. When the driver agrees to the proposal of turning off the assistance, the CPU 42 updates the states of twelve function unit assistance processes in the RAM 45 according to the snowy road driving assistance. Here, the CPU 42 disables the function unit support process specified to be enabled by the snowy road recommendation assistance process. However, even when the function unit assistance process is specified to be enabled by the snowy road recommendation assistance, the enabled state is maintained for those that are enabled by a process other than the snowy road recommendation assistance.

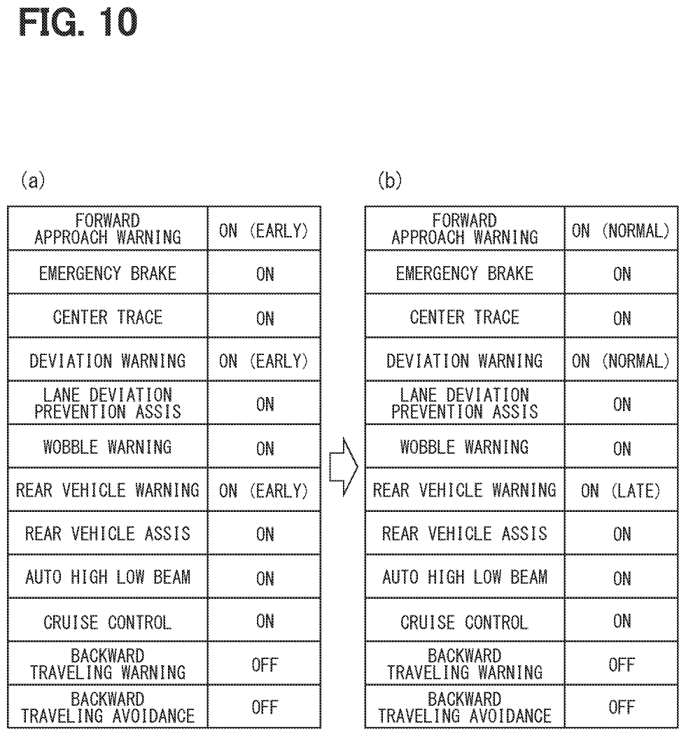

A part (a) of FIG. 10 shows a state before the snowy road recommendation assistance is turned off, and a part (b) of FIG. 10 shows a state after the snowy road recommendation assistance is turned off. In this case, all of the 10 functional unit assistance processes that were enabled before the snowy road recommendation assistance was turned off are maintained in the enabled state. This is because, first, these ten function unit recommendation assistances are specified to be enabled by the expressway recommendation assistance. Secondly, the emergency brake process and the rear vehicle warning process are enabled at the start of the trip according to the setting information data Dis. However, for the two processes of the forward approach warning process and the deviation warning process, the warning timing is returned to the normal timing. In addition, the rear vehicle warning process is returned to the “late” timing.

According to the present embodiment described above, the actions and effects described below can be obtained.

(1) The CPU 42 turns on the expressway recommendation assistance, the snowy road recommendation assistance, and the parking recommendation assistance. After that, when the situation for suggesting them is resolved, the CPU 42 proposes to turn them to the OFF state. When the consent is not obtained, the CPU 42 maintains the ON state. Thereby, when the similar traveling situation occurs again, it is possible to execute the assistance process without re-proposing.

(2) When the CPU 42 determines that the driver driving ability has deteriorated, the CPU 42 notifies that the ability deterioration recommendation assistance is turned on, and keeps the ability deterioration recommendation assistance in the ON state unless the assistance is refused. Thereby, it is possible to maintain the vehicle VC in a safe state as much as possible.

(3) All function unit assistance processes are turned on by the ability deterioration recommendation assistance. Thereby, it is possible to maintain the vehicle VC in a safe state as much as possible. In particular, in the case of the present embodiment, the MRM is turned on when the cruise control process is turned on, so it is possible to activate the MRM when the driver driving ability further deteriorates.

(4) When the CPU 42 determines that the driver attentiveness ability has deteriorated, the CPU 42 notifies that the attentiveness ability deterioration recommendation assistance is turned on, and keeps the attentiveness ability deterioration recommendation assistance in the ON state unless the assistance is rejected. Thereby, it is possible to maintain the vehicle VC in a safe state as much as possible.

(5) The CPU 42 updates the status of the function unit assistance process stored in the RAM 45 to the state indicated by the setting information data Dis when the trip starts. Thereby, even the process whose state is automatically switched to the enabled state by the processes of FIGS. 3 to 7 can be returned to the state set by the driver at the start of the trip.

### Other Embodiments

The above-described embodiment may be modified as follows. The above-described embodiment and the following modifications can be implemented in combination with one another as long as there is no technical contradiction.

### “Situation Assistance Process”

### (a) Assistance Process for Specific Traveling Situations

A recommendation assistance for a low friction test road as the assistance process is recommended, when the coefficient of friction of the road surface on which the vehicle travels is less than or equal to a predetermined value. The assistance is not limited to the snowy road recommendation assistance. For example, the assistance process may be set to a process proposed when any one of a rainy weather, an icy road, or the like is detected. It is not essential that the recommendation assistance for the low friction test road corresponds to only one of a snowy road surface, a rainy road surface, an icy road surface, and the like. For example, the process may be proposed for the snowy and icy roads, but not proposed for the rainy road. Also, different types of functional unit assistance process may be provided depending on whether the road is snowy, icy, or rainy.
The assistance process recommended for traveling on the automobile road is not limited to the expressway recommendation assistance.
The driving assistance process for the traveling situation is not limited to the process exemplified in the above embodiment. For example, a situational assistance process may be provided for the vehicle situation of backing out of the parking lot when the vehicle is launched. This process may be configured to include the backward traveling warning process and the backward traveling avoidance process.
The situation assistance process associated with the traveling situation is not limited to a combination of multiple function unit assistance processes. For example, it may be one specific function unit assistance process.

### (b) Assistance Process for Specific Driving Situations

In the above-described embodiment, it is determined that the driver attentiveness has deteriorated when inattentive driving is performed more than a predetermined number of times per unit time, but the present disclosure is not limited to this. For example, when a driver field of vision is narrow and a part of the required area is out of the field of vision for a predetermined time, it may be determined that the driver attentiveness has deteriorated. Also, when the logical sum of the case where inattentive driving is performed more than a predetermined number of times per unit time and the case where a part of the required area is out of the field of vision for a predetermined time is true, it is determined that the attentiveness has deteriorated.
In the above embodiment, the MRM is enabled when the cruise control process is enabled, but the present disclosure is not limited to this. For example, the MRM may be included in the function unit assistance process independently of the cruise control process, and may be a process enabled when it is determined that the driving ability has deteriorated. However, it is not essential that the MRM is enabled when it is determined that the driving ability has deteriorated, and the MRM may be enabled all the time by default.
In the above-described embodiment, two types of situation assistance processes are provided. The processes are the situation assistance process (also referred to as a deterioration situation assistance process) for coping with the deterioration of the driving ability and the situation assistance process for coping with the deterioration of the attentiveness. However, the present disclosure is not limited to those. For example, for those two, only one of them may be provided.
The situation assistance process associated with the driving situation is not limited to a combination of multiple function unit assistance processes. For example, it may be one specific function unit assistance process.
   “Sensors that Detect Objects”
In the above-described embodiment, the radar device 12, the vehicle exterior camera 22, and the sonar 32 have been exemplified as the sensors for detecting objects that are used in the functional unit assistance process, but the sensors are not limited to these. For example, an optical sensor that receives reflected waves of light such as near-infrared rays may be used. However, it is not essential to use the optical sensor alone. In short, the input may be configured using one or more of various sensors such as the radar device 12, the vehicle exterior camera 22, the sonar 32, and the optical sensor. At this time, it is possible not to use at least some of the inputs for each function unit assistance process as exemplified in the above embodiment. That is, for example, instead of the process using the radar device 12 and the vehicle exterior camera 22, the forward approach warning process may be a process using the optical sensor, or a process using the optical sensor and the exterior camera 22.

### “Function Unit Assistance Process”

The forward approach warning process, the deviation warning process, and the rear vehicle warning process are not limited to those in which the warning timing can be set in three ways according to the driver instructions. For example, the process may be a process that can be set in two ways, or a process that can be set in four or more ways, for example. However, the process may be a process that does not have a degree of freedom in determining the timing.
The backward traveling warning process is not limited to the warning process executed when the vehicle goes backward and there is a risk of colliding with the object. For example, in the process, when there is a risk of colliding with a moving object such as a person or a vehicle among objects, a warning may be issued. Further, for example, the process may be a process of issuing a warning when there is a risk of contacting with an obstacle such as a wall among objects.
The backward traveling warning process is not limited to the vehicle driving intervening process executed when the vehicle goes backward and there is a risk of colliding with the object. For example, when there is a risk of colliding with the moving object such as the person or the vehicle among objects, the vehicle driving intervening process may be executed. Further, for example, the process may be a process of intervening in the vehicle driving when there is the risk of contacting with the obstacle such as the wall among objects.
The function unit assistance process provided in the vehicle is not limited to the processes shown in FIG. 2. For example, for the twelve processes shown in FIG. 2, only one or more and eleven or less of them may be provided. However, the greater the number of function unit assistance processes provided in the vehicle, the greater the merit of executing the commands defined by the assistance recommendation program PRr. Therefore, it is desirable that the vehicle has multiple function unit assistance processes. In particular, it is more desirable that the vehicle has five or more processes, and is further more desirable that the vehicle has ten or more processes.

### “Proposal Process”

In the above-described embodiment, when a situation changes from a non-specific situation to a specific situation, the proposal is made every time even within the same trip, but the present disclosure is not limited to this. For example, when the consent is not obtained for the process of S46 in FIG. 5, the process of S46 may not be executed when re-entering the expressway after getting off the expressway during the trip. In addition, not only within the trip, for example, when a proposal to enable the specific situation assistance process such as the expressway recommendation assistance is not accepted, the proposal to enable the specific situation assistance process may not be performed for a predetermined number of days.
In the above-described embodiment, the human interface 72 has the speaker, and the example is shown in which the proposal is made by an audio signal, but the present disclosure is not limited to this. For example, the human interface 72 may include a heads-up display to provide a proposal using visual information. Means for displaying visual information is not limited to the head-up display, and may be a display device in the instrument panel.

### “Inquiry Process”

In the above embodiment, only when transitioning from the specific situation to the non-specific situation or when there is no record of inquiring about disabling the situation assistance process for the specific situation within the same trip, the inquiring about disabling the process is made. However, the present disclosure is not limited to this. For example, after the negative determination is made in the process of S56 of FIG. 5, the process of S54 may be executed when entering and exiting the expressway again within the trip.
When the parking is completed while the parking recommendation assistance is in the ON state, the process of S94 may not be executed.
In the above-described embodiment, the human interface 72 has the speaker, and the example is shown in which the inquiry is made by an audio signal, but the present disclosure is not limited to this. For example, the human interface 72 may include the heads-up display to provide the inquiry using visual information.

### “Human Interface”

In the above embodiment, the microphone was exemplified as the human interface for input operation from the driver, but the present disclosure is not limited to this. For example, the human interface may be a switch or the like.

### “Enabling or Disabling Situation Assistance Process for Specific Driving Situations”

In the above-described embodiment, the state of the functional unit assistance process is stored in the RAM 45, but the present disclosure is not limited to this. For example, the state may be stored in storage device 46.
In the above-described embodiment, each time a trip is started, the setting state of enabling or disabling each function unit assistance process is initialized to the state determined by the setting information data Dis, but the present disclosure is not limited to this. For example, the state may be initialized at the start of the trip after the day after the start of the previous trip. As a result, for example, when the driver stops at a store or the like during driving and then starts driving again, the setting state of the previous trip can be utilized.
For example, in addition to being at the start of the trip, the state may be initialized on the condition that there is the record in which the situation that was considered enabled has been resolved. In this case, it is desirable to update only those with the record of resolving the status that was enabled, instead of updating all of the function unit assistance processes to the state determined by the setting information data Dis. That is, for example, when there is a record of a negative determination in the process of S56, the state of the function unit assistance process related to the expressway recommendation assistance may be initialized on condition that the vehicle VC is not on the expressway at the start of the trip. At this time, when there is no record in which the state to be enabled has been resolved, the function unit assistance process that is enabled by the situation assistance process remains enabled. That is, for example, when the snowy road recommendation assistance is enabled and the vehicle is still on a snowy road at the start of the trip, the function unit assistance process enabled by the snowy road recommendation assistance remains enabled.
For example, with respect to the parking recommendation assistance, the process of S94 may be executed at the start of the next trip.
The process of determining, at the start of the trip, whether each of the function unit assistance processes is set to be enabled or disabled based on the setting information data Dis is not limited to the process of initializing the state to the state set based on the setting information data Dis at the start of the trip. For example, the process may be a process of initializing to a state set by the setting information data Dis at the end of the trip. However, in this case, the state of the function unit assistance process is stored in the storage device 46 instead of being stored in the RAM 45.
For example, when a specific traveling situation is resolved, an inquiry is made as to whether to disable an assistance process for the specific traveling situation. After that, when the assistance process is disabled, the initialization may not be performed. That is, for example, when a negative determination is made in the process of S56, the function unit assistance process that is enabled by the expressway recommendation assistance may be excluded from the initialization targets.

### “Behavior Detection Process”

In the above-described embodiment, the behavior of the vehicle is detected based on the shaking of the image in front of the vehicle ascertained from the vehicle exterior image data Dpo of the vehicle exterior camera 22, but the present disclosure is not limited to this. For example, the behavior of the vehicle may be detected based on at least one of the wheel-turning angle θs detected by the steering angle sensor 62 and the steering torque Trqs detected by the torque sensor 64. Further, for example, the vehicle behavior may be detected based on the lateral acceleration Gy detected by the acceleration sensor 66.

### “Driving Assistance Apparatus”

The driving assistance apparatus is not limited to the ADAS ECU 40. For example, the ADAS ECU 40 and at least a part of an ECU that executes a process of detecting an object based on the output of a sensor that detects the object may be integrally formed. That is, for example, the ADAS ECU 40, the millimeter wave ECU the image ECU 20, and the sonar ECU 30 may be integrally formed.

Further, for example, the ADAS ECU 40 and at least a part of brake ECU steering ECU 90 and drive ECU 100 may be integrally formed.

### “Execution Device”

An execution device is not limited to one that includes a CPU and a program storage device that stores a program and executes a software process. For example, a dedicated hardware circuit such as an ASIC may be provided to execute a hardware process for at least part of results obtained by the software process in the above embodiment. That is, the execution device may have any one of the following configurations (a) to (c). (a) The device includes a process device for executing all of the above processes according to a program, and a program storage device. (b) The device includes a process device and a program storage device for executing a part of the above processes according to a program, and a dedicated hardware circuit for executing the remaining processes. (c) The device includes a dedicated hardware circuit to perform all of the above processes. Here, there may be multiple software execution devices provided with the process device and the program storage device, or multiple dedicated hardware circuits.

### “Computer”

A computer for assisting traveling is not limited to the CPU 42 illustrated in FIG. 1. For example, among the processes shown in FIGS. 5 to 7 may be executed by a mobile terminal of the user, and the processes shown in FIGS. 3 and 4 may be executed by the CPU 42. Here, for example, the processes of S50 and S58 in FIG. 5 are processes in which the mobile terminal requests the ADAS ECU 40 to enable or disable the state.

Although the present disclosure has been made in accordance with the embodiments, it is understood that the present disclosure is not limited to such embodiments and structures. The present disclosure incorporates various modifications and variations within the scope of equivalents. In addition, various combinations and forms, and further, other combinations and forms including only one element, or more or less than these elements are also within the sprit and the scope of the present disclosure.

The device and the method described in the present disclosure may be implemented by a special purpose computer created by configuring a memory and a processor programmed to execute one or more particular functions embodied in computer programs. Alternatively, the device and the method described in the present disclosure may be implemented by a special purpose computer created by configuring a processor provided by one or more special purpose hardware logic circuits. Alternatively, the device and the method described in the present disclosure may be implemented by one or more special purpose computers created by configuring a combination of a memory and a processor programmed to execute one or more particular functions and a processor provided by one or more hardware logic circuits. The computer programs may be stored, as instructions being executed by a computer, in a tangible non-transitory computer-readable medium.

Here, the process of the flowchart or the flowchart described in this application includes a plurality of sections (or steps), and each section is expressed as, for example, S10. Further, each section may be divided into several subsections, while several sections may be combined into one section. Furthermore, each section thus configured may be referred to as a device, module, or means.

1. A driving assistance apparatus for assisting driving of a vehicle, the apparatus comprising:
a storage configured to store association data;
an execution device,
wherein
the association data associates a plurality of traveling situations with a plurality of situation assistance processes,
each situation assistance process is a driving assistance process for a specific traveling situation,
the execution device is configured to:
acquire a value of a traveling situation variable that is a variable indicating a traveling situation of the vehicle among the plurality of traveling situations;
operate a human interface to propose, to a driver of the vehicle, at least one of the plurality of situation assistance processes according to the association data based on the value of the traveling situation variable; and
when detecting that the driver has approved a proposal of the at least one of the plurality of situation assistance processes via the human interface, enable a setting of an approved situation assistance process.

2. The driving assistance apparatus according to claim 1, wherein
the execution device is further configured to:
enable a predetermined situation assistance process among the plurality of situation assistance processes when the value of the traveling situation variable indicates a predetermined situation;
inquire of the driver whether to disable the predetermined situation assistance process when the value of the traveling situation variable does not indicate the predetermined situation after the predetermined situation assistance process is enabled;
disable the predetermined situation assistance process when the driver provides an instruction for disabling the predetermined situation assistance process according to an inquiry result; and
continue an enabled setting of the predetermined situation assistance process that has been enabled, when the driver does not provide the instruction according to the inquiry result.

3. The driving assistance apparatus according to claim 1, wherein
each situation assistance process includes a combination of a plurality of function unit assistance processes,
the plurality of function unit assistance processes have a plurality of types, and
in each of the plurality of function unit assistance processes, at least one of an electronic unit that is an operation target, an input signal, or an output calculation for an input is different from another function unit assistance process.

4. The driving assistance apparatus according to claim 3, wherein
the plurality of function unit assistance processes include at least two of:
a forward approach warning process of issuing a warning when an obstacle exists in front of the vehicle;
an emergency brake process of applying a braking force to the vehicle when the obstacle exists in front of the vehicle;
a center trace process of controlling the vehicle to travel in a center of a vehicle lane;
a deviation warning process of issuing a warning when the vehicle deviates from the vehicle lane;
a lane deviation prevention assistance process of operating a wheel-turning actuator to return the vehicle to the vehicle lane when the vehicle deviates from the vehicle lane;
a wobble warning process of issuing a warning indicating that the vehicle wobbles when the vehicle wobbles with respect to the vehicle lane and travels;
a rear vehicle warning process of issuing a warning indicating that the vehicle is likely to collide with a rear vehicle positioned in a rear of the vehicle;
a rear vehicle assistance process of operating the wheel-turning actuator to avoid a situation of colliding with the rear vehicle when the situation exists;
an auto high-low beam process of switching a headlight between high beam and low beam;
a cruise control process;
a backward traveling warning process of issuing a warning when the vehicle goes backward and an obstacle exists in an advancing direction of the vehicle; or
a backward traveling avoidance process of applying the braking force to the vehicle when the vehicle goes backward and the obstacle exists in the advancing direction of the vehicle.

5. The driving assistance apparatus according to claim 3, wherein
the plurality of situation assistance processes include a first situation assistance process and a second situation assistance process,
the plurality of function unit assistance processes include a predetermined function unit assistance process,
the first situation assistance process includes the predetermined function unit assistance process,
the second situation assistance process does not include the predetermined function unit assistance process, and
the execution device enables the predetermined function unit assistance process when the first situation assistance process and the second situation assistance process are enabled.

6. The driving assistance apparatus according to claim 3, wherein
the plurality of situation assistance processes include a first situation assistance process and a second situation assistance process,
the plurality of function unit assistance processes include a warning assistance process of issuing a predetermined warning,
the first situation assistance process and the second situation assistance process include the warning assistance process,
a timing of the predetermined warning in the first situation assistance process is earlier than in the second situation assistance process, and
the execution device employs, as the timing of the predetermined warning, a timing related to a setting of the first situation assistance process when the first situation assistance process and the second situation assistance process are enabled.

7. The driving assistance apparatus according to claim 3, wherein
the situation assistance process includes at least one of:
a process of setting a situation where the vehicle travels in an automobile road to the specific traveling situation,
a process of setting a situation where a friction coefficient of a road surface on which the vehicle travels to the specific traveling situation, or
a process of setting a situation where the vehicle is positioned in a parking lot to the specific traveling situation.

8. The driving assistance apparatus according to claim 3, wherein
the situation assistance process includes, in addition to an assistance process for the specific traveling situation, an unstable situation assistance process that is a driving assistance process for coping with an unstable driving situation when a behavior of the vehicle is unstable,
the unstable situation assistance process includes a predetermined process among the plurality of function unit assistance processes,
the execution device is further configured to:
detect the behavior of the vehicle;
notify the driver that the unstable situation assistance process is enabled when the behavior of the vehicle is unstable;
when the driver refuses to enable the unstable situation assistance process, maintain a current state of the predetermined process; and
when the driver does not prohibit enablement of the unstable situation assistance process, enable the unstable situation assistance process.

9. The driving assistance apparatus according to claim 3, wherein
the situation assistance process includes, in addition to an assistance process for a specific traveling situation, a deterioration situation assistance process that is a driving assistance process for coping with a deterioration of an attentiveness of the driver when the attentiveness deteriorates,
the deterioration situation assistance process includes a predetermined process among the plurality of function unit assistance processes, and
the execution device is further configured to:
determine whether the attentiveness of the driver is equal to or less than a predetermined value based on driver image data output from a capture device;
notify the driver that the deterioration situation assistance process is enabled when determining that the attentiveness of the driver is equal to or less than a predetermined value;
when the driver prohibits enablement of the deterioration situation assistance process, maintain a current state of the predetermined process; and
when the driver does not prohibit the enablement of the deterioration situation assistance process, enable the deterioration situation assistance process.

10. The driving assistance apparatus according to claim 3, wherein
the execution device is further configured to:
accept an input by the driver for performing a setting of either enabling or disabling the driving assistance process;
store an accepted setting in the storage; and
enable or disable each function unit assistance process according to the setting stored in the storage even when, at a start of a trip, a state of a function unit assistance process is indicated by the situation assistance process that has been enabled from an end of a previous trip and is different from the setting stored in the storage.

11. A driving assistance method comprising:
storing association data in a storage, wherein the association data associates a plurality of traveling situations with a plurality of situation assistance processes, and each situation assistance process is a driving assistance process for a specific traveling situation;
acquiring a value of a traveling situation variable that is a variable indicating a traveling situation of a vehicle among the plurality of traveling situations;
operating a human interface to propose, to a driver of the vehicle, at least one of the plurality of situation assistance processes according to the association data based on the value of the traveling situation variable; and
when detecting that the driver has approved a proposal of the at least one of the plurality of situation assistance processes via the human interface, enabling a setting of an approved situation assistance process.

12. A computer-readable non-transitory storage medium storing an assistance recommendation program configured to cause a processor to:
store association data in a storage, wherein the association data associates a plurality of traveling situations with a plurality of situation assistance processes, and each situation assistance process is a driving assistance process for a specific traveling situation;
acquire a value of a traveling situation variable that is a variable indicating a traveling situation of a vehicle among the plurality of traveling situations;
operate a human interface to propose, to a driver of the vehicle, at least one of the plurality of situation assistance processes according to the association data based on the value of the traveling situation variable; and
when detecting that the driver has approved a proposal of the at least one of the plurality of situation assistance processes via the human interface, enable a setting of an approved situation assistance process.

13. The driving assistance apparatus according to claim 1, further comprising:
a processor that serves as the execution device; and
a memory that serves as the storage.
